(19) United States
(12) Patent Application Publication
(10) Pub. No.: US 2007/0035228 A1
(43) Pub. Date: Feb. 15, 2007

(54) Electrode-less flat lamp

(76) Inventor: Chao-Lin Wu, Tainan Science Park (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/491,983

(22) Filed: Jul. 25, 2006

(30) Foreign Application Priority Data
Aug. 9, 2005 (TW) 094213548

(51) Int. Cl. H01J 63/04

(52) U.S. Cl. 313/485; 313/495; 313/292; 313/309; 313/160

(57) ABSTRACT

The present invention relates to an electrode-less flat lamp, which comprises oppositely located first and second flat plates, at least one enclosing wall mounted around the region between the first and second flat plates to define a sealing chamber, and a magnetic core attached to the outside of the second flat plate, wherein at least one of the first and second flat plates is pervious to visible lights. The present invention is characterized in that: a plurality of support pillars are extended integrally from the inside of at least one of the first and second flat plates, and the support pillars are tapered from respective bottoms toward respective free ends so that the support pillars can block fewer visible lights by point shape contact with the visible lights when a fluorescence material is excited by an electromagnetic wave of the magnetic core for emitting the visible lights.

### FIELD OF THE INVENTION

The present invention relates to a flat lamp, and more particularly to an electrode-less flat lamp able to promote luminous efficiency and luminous uniformity.

### BACKGROUND OF THE INVENTION

An illuminator is an essential article of everyday use. In order to provide people with more stable illumination to fulfill various requirements, a fluorescent lamp, a mercury lamp, and a most advanced power-saving lamp are disclosed to generate optimum illumination.

In the commonly utilized fluorescent lamp, the filament electrodes are mounted on two ends of a fluorescent tube for discharging electricity. In addition, the fluorescent tube is filled with an insert gas, and the inner wall of the fluorescent tube is coated with a layer of fluorescence material. When the electrodes discharge electricity, the electrons impact the fluorescence material on the inner wall of the fluorescent tube to generate the visible lights for illumination. In order to offer the ability to bear the atmosphere pressure, the general fluorescent lamp can only be formed in a spherical or cylindrical shape. Although a flat fluorescent tube has been disclosed to provide a larger area light source, the air inside the fluorescent tube must be drained out completely for the purpose of manufacturing the flat fluorescent lamp. However, this vacuum process allows the negative pressure to be formed inside the fluorescent tube and causes the center region of the fluorescent tube to be sunken or broken, resulting in the poor quality.

In Taiwan Pat. No. 594,830, a cold cathode flat lamp is disclosed, in which two elongated trenches are formed on two plate-shaped substrates to define support sections or a wavy structure is sandwiched between two plate-shaped substrates to support the plate-shaped substrates and to prevent the external force or the negative pressure from sinking or breaking the plate-shaped substrates. However, this cold cathode flat lamp has the following drawbacks:

1. In the conventional cold cathode flat lamp, some visible lights pass through the chamber's inner wall, which is coated with fluorescence material, and then pass through the plate-shaped substrates to the outside. In fact, however, the visible lights touch the inner wall of the chamber first before passing therethrough. However, the inner wall of the chamber and the plate-shape substrates are made of two kinds of different materials so they have different refractive indexes. Accordingly, the luminous efficiency of the conventional cold cathode flat lamp is significantly reduced after the visible lights are twice reflected and obstructed.

2. After the electrodes of the conventional cold cathode flat lamp discharge electricity, some visible lights are reflected by the inner wall of the chamber and the plate-shaped substrates, and then transmitted to the outside. The other visible lights are transmitted to the outside by passing through the plate-shaped substrates directly. The different paths cause conventional cold cathode flat lamp to generate two kinds of visible lights of different strengths. As a result, the luminous uniformity of the conventional cold cathode flat lamp is significantly affected.

3. The electrode number of the conventional cold cathode flat lamp is doubly increased with the increase of chamber number. In addition, the electrode of the conventional cold cathode flat lamp is principally an expensive electrode such as a nickel electrode, a silver electrode, a copper electrode, a molybdenum electrode, or a niobium electrode, causing disablement in reducing cost.

### SUMMARY OF THE INVENTION

In view of the above-mentioned conventional drawbacks, a major object of the present invention is to disclose an electrode-less flat lamp able to promote luminous efficiency and luminous uniformity.

In order to achieve the object of the present invention, an electrode-less flat lamp is comprised of oppositely located first and second flat plates, at least one enclosing wall mounted around the region between the first and second flat plates to define a sealing chamber, and a magnetic core attached to the outside of the second flat plate, wherein at least one of the first and second flat plates is pervious to visible lights. The present invention is characterized in that: a plurality of support pillars are extended integrally from the inside of at least one of the first and second flat plates, and the support pillars are tapered from respective bottoms toward respective free ends so that the support pillars can block fewer visible lights by point shape contact with the visible lights when a fluorescence material is excited by an electromagnetic wave of the magnetic core for emitting the visible lights.

### BRIEF DESCRIPTION OF THE DRAWINGS

FIG. 1 is an elevational diagram of a first preferred embodiment of the present invention.

FIG. 2 is an elevational, exploded diagram of the first preferred embodiment of the present invention.

FIG. 3 is a cross-sectional view of the first preferred embodiment of the present invention.

FIG. 4 is an elevational, exploded diagram of a second preferred embodiment of the present invention.

FIG. 5 is a cross-sectional view of the second preferred embodiment of the present invention.

FIG. 6A is a first schematic diagram showing the support pillars arranged on one of the flat plates of the present invention.

FIG. 6B is a second schematic diagram showing the support pillars arranged on one of the flat plates of the present invention.

FIG. 6C is a third schematic diagram showing the support pillars arranged on one of the flat plates of the present invention.

FIG. 6D is a fourth schematic diagram showing the support pillars arranged on one of the flat plates of the present invention.

FIG. 6E is a fifth schematic diagram showing the support pillars arranged on one of the flat plates of the present invention.

FIG. 6F is a sixth schematic diagram showing the support pillars arranged on one of the flat plates of the present invention.

FIG. 6G is a seventh schematic diagram showing the support pillars arranged on one of the flat plates of the present invention.

FIG. 6H is an eighth schematic diagram showing the support pillars arranged on one of the flat plates of the present invention.

### DETAILED DESCRIPTION OF THE PREFERRED EMBODIMENT

The description taken with the drawings make the structures, features, and embodiments of the present invention apparent to those skilled in the art how the present invention may be embodied in practice.

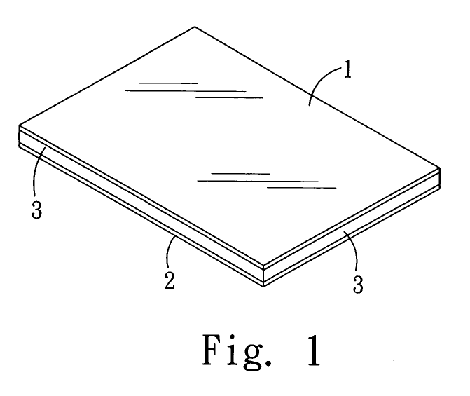

Referring to FIGS. 1 through 3, a first preferred embodiment of the present invention generally comprises a first flat plate 1 and a second flat plate 2, which are located oppositely. At least one of these two flat plates is pervious to visible lights. In addition, at least one enclosing wall 3 is mounted around the region between these two flat plates to define a sealing chamber 4. The sealing chamber 4 is filled with an inert gas 41. Besides, the inner surface of the sealing chamber 4 is coated with a layer of fluorescence material 42. A magnetic core 43 is attached to the outer surface of the second flat plate 2. Moreover, the enclosing wall 3 is pervious or not pervious to visible lights.

The present invention is characterized in that several support pillars 5 are extended integrally from the inner surface of at least one of the flat plates. These support pillars 5 are tapered from the respective bottoms toward the respective free ends to enable the support pillars to block fewer visible lights by point shape contact with the visible lights when the fluorescence material is excited by an electromagnetic wave of the magnetic core 43 for emitting the visible lights.

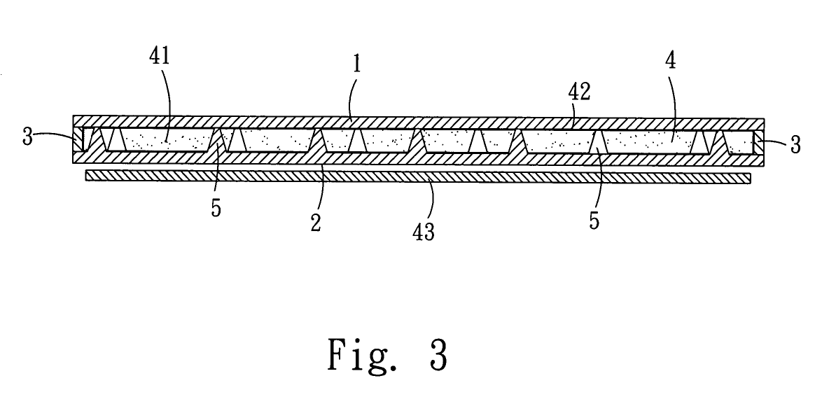

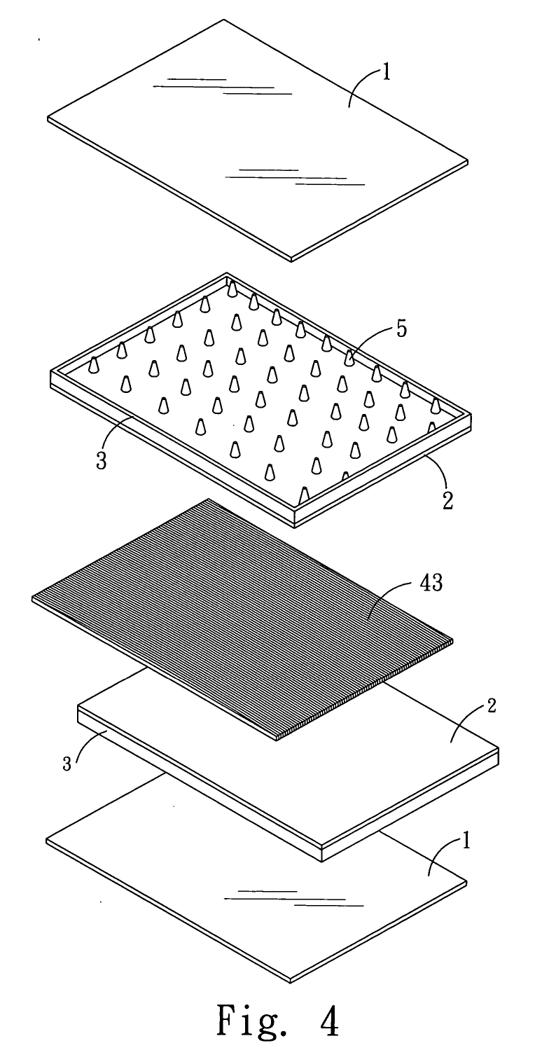

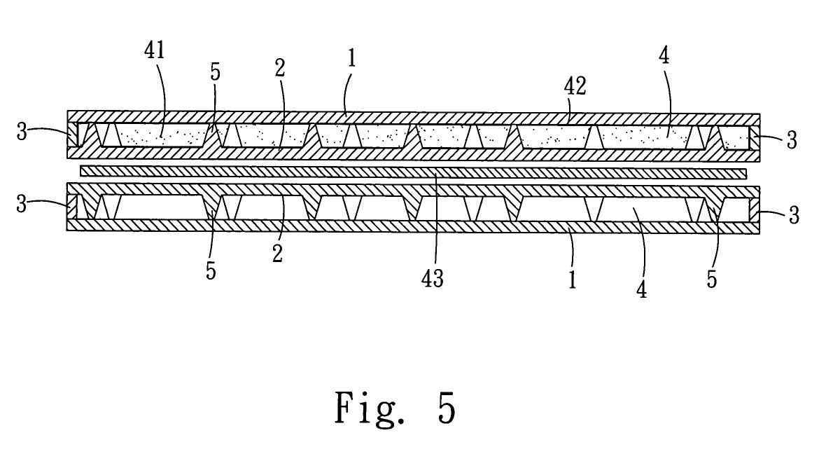

Referring to FIG. 4 and FIG. 5, a second preferred embodiment of the present invention is illustrated. There are provided with two identical units, wherein in each unit, a sealing chamber 4 is defined by the first flat plate 1, the second flat plate 2, and the opaque enclosing wall 3 between the flat plate 1 and the flat plate 2. In addition, the magnetic core 43 is sandwiched between the second flat plates 2 of these two identical units. As a result, the first flat plates 1 of these two identical units are designed to be pervious to visible lights.

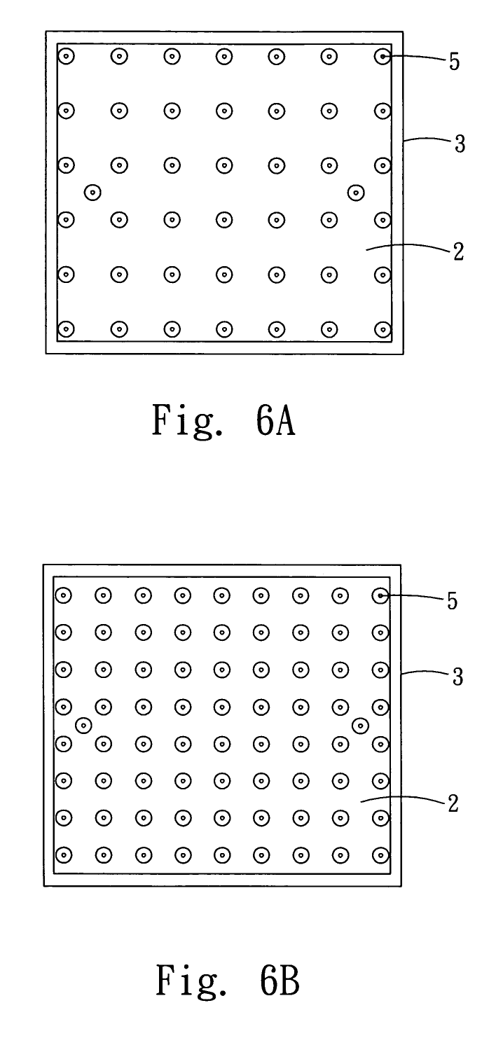

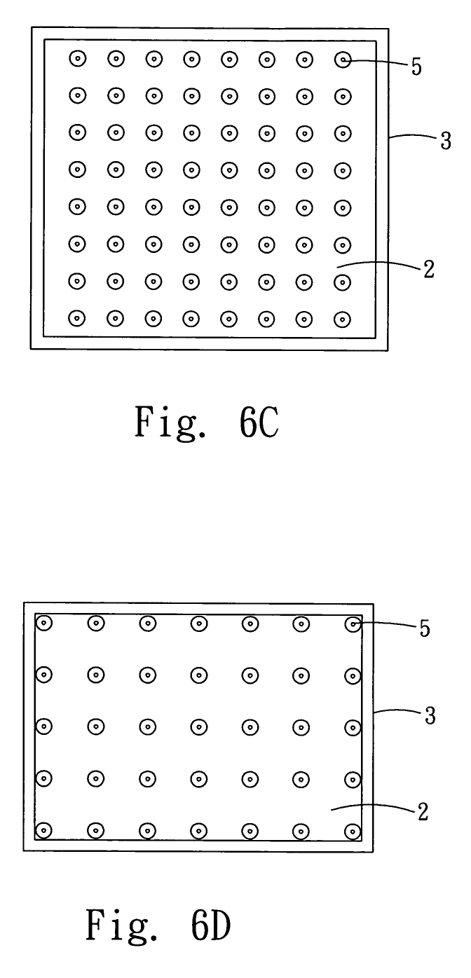

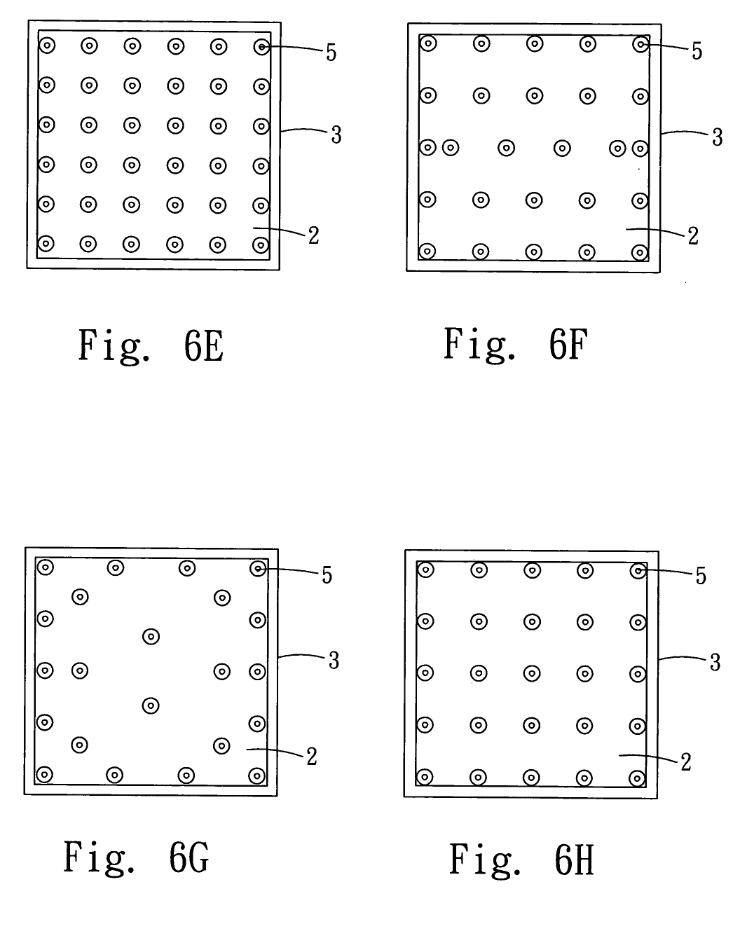

Referring to FIGS. 6A to 6H, the support pillars 5 are arranged on the inner surface of the first flat plate 1 or the second flat plate 2 in a crisscross or reticulated pattern. In addition, the support pillars 5 between the first flat plate 1 and the second flat plate 2 can protect the center regions of these flat plates against sinking or breaking under the negative pressure formed during the vacuuming process. Besides, when the apparatus of the present invention emits the visible lights, the support pillars 5 that have the tapered shape allow the visible lights to have point shape contact with the support pillars. Moreover, the support pillars 5 are made of the same material as these flat plates 1 and 2, and extended integrally from the flat plates 1 and 2. As a result, they have identical refractive index. Accordingly, the luminous intensity of every light beam will not be altered by the support pillars 5 so as to allow the light beam to uniformly and directly pass through the wall of the sealing chamber 4.

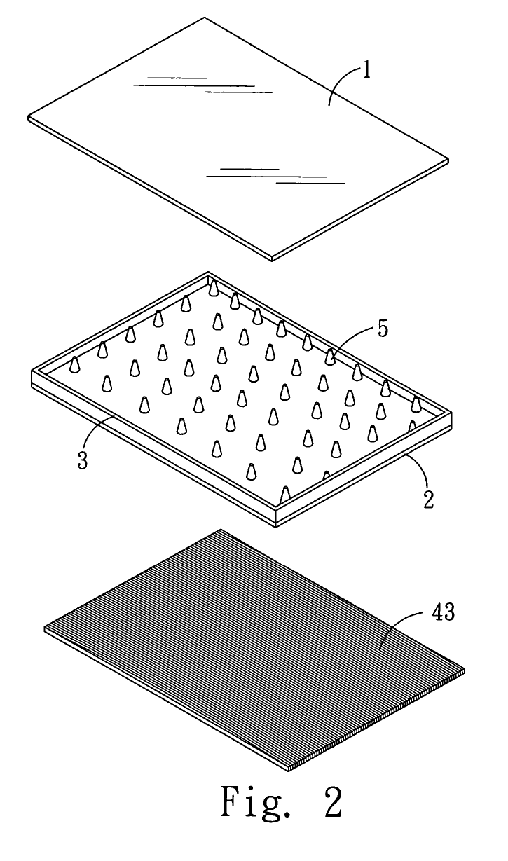

Referring again to FIGS. 1 and 2, the sealing chamber 4 has no electrode on both ends so the present invention can reduce the cost effectively.

The present invention has the following features:

1. The support pillars of the present invention do not hinder the visible lights from passing and do not affect or alter luminous efficiency and luminous uniformity.

2. The support pillars, which are integrally extended from the flat plates, are made of the same material as the flat plates, whereby they have identical refractive index to prevent the luminous intensity from alteration for improving the luminous uniformity.

3. The cost can be maximally reduced since no electrode is formed in the present invention.

On the basis of the description mentioned above, the present invention indeed satisfies the requirements for patentability since it provides practicability and has never been published or used publicly. Therefore, it is submitted for a patent.

With the invention thus explained, it is apparent that various modifications and variations can be made without departing from the scope of the invention. It is therefore intended that this invention be limited only as indicated in the appended claims.

What the invention claimed is:

1. An electrode-less flat lamp, which comprises oppositely located first and second flat plates, at least one enclosing wall mounted around a region between said first and second flat plates to define a sealing chamber, and a magnetic core attached to the outside of said second flat plate and in which at least one of said first and second flat plates is pervious to visible lights, characterized in that:
a plurality of support pillars are extended integrally from the inside of at least one of said first and second flat plates, and said support pillars are tapered from respective bottoms toward respective free ends so that said support pillars can block fewer visible lights by point shape contact with said visible lights when a fluorescence material is excited by an electromagnetic wave of said magnetic core for emitting said visible lights.

2. An electrode-less flat lamp according to claim 1, characterized in that said support pillars are arranged on an inner surface of at least one of said first and second flat plates in a crisscross pattern.

3. An electrode-less flat lamp according to claim 1, characterized in that said support pillars are arranged on an inner surface of at least one of said first and second flat plates in a reticulated pattern.

4. An electrode-less flat lamp according to claim 1, characterized in that said sealing chamber is filled with an inert gas.

5. An electrode-less flat lamp according to claim 1, characterized in that an inner surface of said sealing chamber is coated with said fluorescence material.

6. An electrode-less flat lamp according to claim 1, characterized in that said enclosing wall is pervious to said visible lights.

7. An electrode-less flat lamp according to claim 1, characterized in that said enclosing wall is not pervious to said visible lights.

8. An electrode-less flat lamp according to claim 1, characterized in that said first flat plate, said second flat plate, and said enclosing wall jointly define a first unit, and said magnetic core is mounted between said second flat plate of said first unit and a second flat plate of a second unit, wherein said second unit and said first unit are identical in structure so that said first flat plates of said first and second units are both designed to be pervious to said visible lights.

9. An electrode-less flat lamp according to claim 8, characterized in that said sealing chamber of at least one of said first unit and said second unit is filled with an inert gas.

10. An electrode-less flat lamp according to claim 8, characterized in that an inner surface of said sealing chamber of at least one of said first unit and said second unit is coated with said fluorescence material.
